(19) United States
(12) Patent Application Publication
(10) Pub. No.: US 2008/0242384 A1
(43) Pub. Date: Oct. 2, 2008

(54) MOBILE DEVICE HOUSING AND METHOD FOR MANUFACTURING SUCH

(75) Inventors: CHE-YUAN HSU, Shindian (TW); KEN-HOLM HANSEN, Faarevejle (DK)

Correspondence Address: PCE INDUSTRY, INC.;ATT. CHENG-JU CHIANG, 458 E. LAMBERT ROAD, FULLERTON, CA, 92835, US

(73) Assignee: SUTECH TRADING LIMITED, Tortola (VG)

(21) Appl. No.: 11/839,475

(22) Filed: Aug. 15, 2007

(30) Foreign Application Priority Data
Mar. 30, 2007 (CN) 200710073752.0

(51) Int. Cl. H04M 1/00; B60P 7/02

(52) U.S. Cl. 455/575.8; 264/129; 264/238

(57) ABSTRACT

A housing assembly (100), used, e.g., in a mobile device (300), includes a housing body (10) and an attached unit (20). The housing body defines a display opening (110). The attached unit includes a base layer (21) and an electronic ink layer (22). The attached unit is received in the display opening and is configured for providing/displaying information and/or graphics thereon. The housing body moldingly receives the display lens therein, via an injection molding process.

### CROSS-REFERENCE TO RELATED APPLICATIONS

This application is related to a co-pending U.S. patent application Ser. No. 11/551,675 (Attorney Docket No. US8846), entitled “COVER FOR A MOBILE DEVICE”, by Chang-Qing Yang et al. This application has the same assignee as the present application, which has been filed on Oct. 20, 2006, and is also related to other three co-pending U.S. patent application Ser. Nos. 11/690,031 (Attorney Docket No. US12480), entitled “CAMERA HOUSING WITH A DISPLAY LENS, METHOD FOR MAKING THE CAMERA HOUSING, AND CAMERA USING THE HOUSING”, by Jin-Feng Gao et al; 11/752,904 (Attorney Docket No. US12646), entitled “MOBILE DEVICE HOUSING WITH ATTACHED UNIT, AND METHOD FOR MAKING THE MOBILE DEVICE HOUSING”, by Jin-Feng Gao et al; and 11/831,927 (Attorney Docket No. US13893), entitled “MOBILE DEVICE HOUSING WITH ATTACHED UNIT, AND METHOD FOR MAKING THE MOBILE DEVICE HOUSING”, by Che-Yuan Hsu et al. The above-identified applications are incorporated herein by reference.

### BACKGROUND OF THE INVENTION

1. Field of the Invention

The present invention relates to mobile device housings and, particularly, to a mobile device housing with an electronic ink layer and a method for manufacturing such a housing.

2. Description of Related Art

With the development of recent technology for displaying information and/or graphics, electronic ink has become a new material for use in housing of electronic devices. Electronic ink is usually formed of a great number of tiny capsules suspended in a liquid medium, and each capsule contains transparent liquid. Many white motes having positive charge and black motes having negative charge suspend in the liquid contained in each capsule. When a capsule is placed into an electric field, white motes suspended in the capsule swarm to one direction and black motes swarm to the opposite direction. Thus, the capsule can become white or black in either direction. In operation, electronic ink is pressed onto the housing of electronic devices to form an electronic ink layer. When a special electronic field influences the electronic ink layer, each capsule of the electronic ink layer displays a proper color. Thus, information and/or graphics can thereby displayed on the housing of electronic devices provided with such a layer.

Generally, a conventional method for manufacturing a mobile device housing with an electronic ink layer includes the following steps: providing a housing body and a conductive transparent film; pressing electronic ink onto a surface of the film to form the electronic ink layer on its surface; applying glue/adhesive on the electronic ink layer; attaching the film onto the housing body via the glue/adhesive; and pressing the film with a roller to fix the film on the housing body.

However, in this conventional method, it is usually difficult to form a flat surface on the film when using the roller to press the film. Furthermore, the pressing of the film requires more time, and thus the manufacturing efficiency is decreased.

Therefore, an improved mobile device housing with an electronic ink layer is desired in order to overcome the above-described shortcomings.

### SUMMARY OF THE INVENTION

In one present embodiment thereof, a housing assembly used in a mobile device includes a housing body and an attached unit. The housing body defines a display opening. The attached unit contains a base layer and an electronic ink layer. The attached unit is received in the display opening and is configured for providing information and/or graphics. The housing body moldingly receives the display lens/screen therein, via an injection molding process.

Other advantages and novel features will become more apparent from the following detailed description of the present embodiments, when taken in conjunction with the accompanying drawings.

### BRIEF DESCRIPTION OF THE DRAWINGS

Many aspects of the present mobile device housing can be better understood with reference to the following drawings. The components in the drawings are not necessarily drawn to scale, the emphasis instead being placed upon clearly illustrating the principles of the present mobile device housing. Moreover, in the drawings like reference numerals designate corresponding parts throughout the several displays.

FIG. 1 is a perspective view of a present embodiment of a housing for a mobile device;

FIG. 2 is an exploded view of the housing, as shown in FIG. 1;

FIG. 3 is a cross-sectional view of the housing, taken along line III-III in FIG. 1;

FIG. 4 is a cross-sectional view of another embodiment of a housing for a mobile device;

FIG. 5 is a cross-sectional view of a mobile electronic device using the housing shown in FIG. 1, with the housing shown in phantom view to schematically indicate the mobile electronic device in its fully assembled state;

FIG. 6 is a schematic view of a female mold of an injection mold for making the housing in FIG. 1;

FIG. 7 is a schematic view of a male mold of the injection mold for making the housing in FIG. 1;

FIG. 8 is a schematic view of the male mold in FIG. 7, with an attached unit being fixed therein;

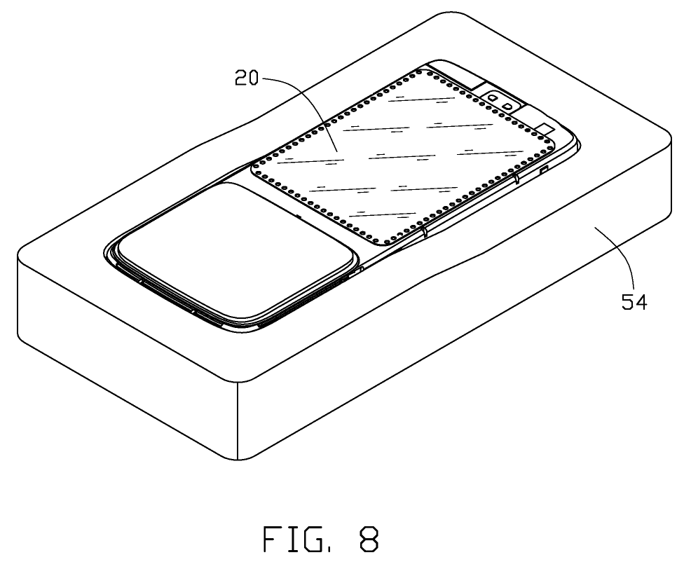

FIG. 9 is a sectioned, schematic view of the female mold in FIG. 6 and the male mold in FIG. 7, being used together, shown in a closed state; and

FIG. 10 is a schematic view of the female mold and the male mold of FIG. 9, with the housing molded therein.

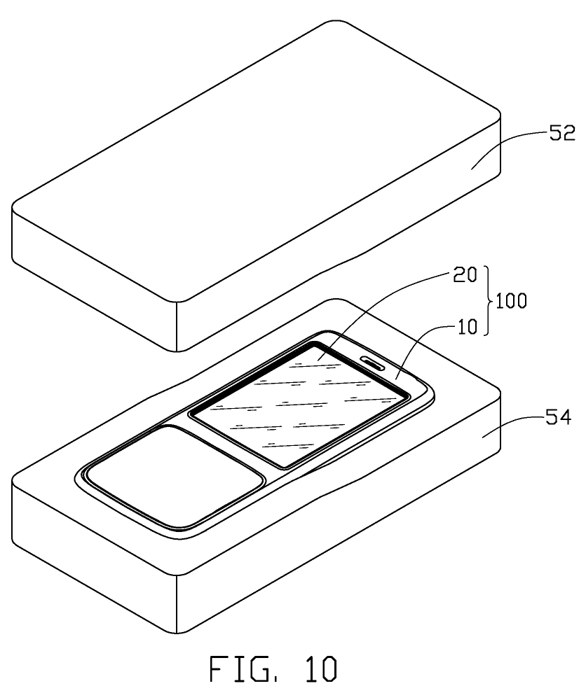

### DETAILED DESCRIPTION OF THE INVENTION

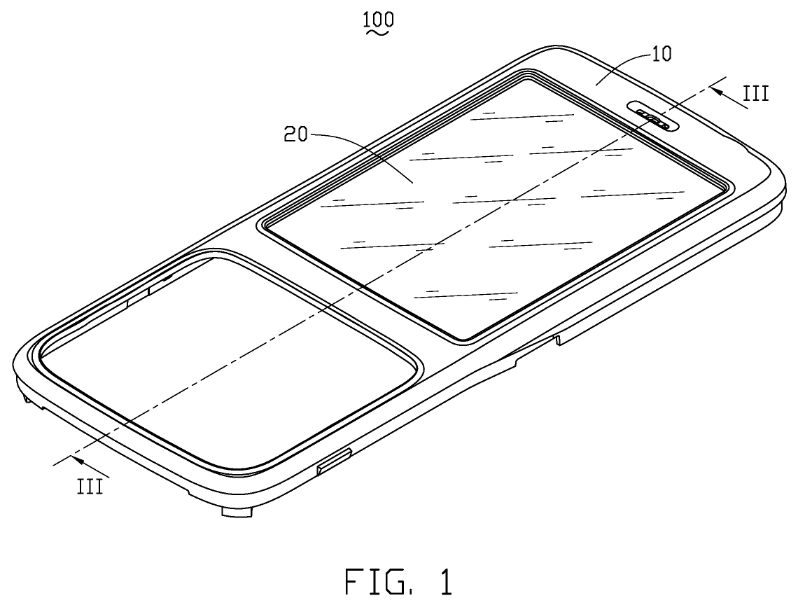

Referring to FIG. 1, in a preferred embodiment, a housing assembly 100 for a mobile device (not shown in FIG. 1), e.g. a mobile phone, PDA, or digital camera, includes at least a housing body 10 and an attached unit 20. The attached unit 20 is received in the housing body 10.

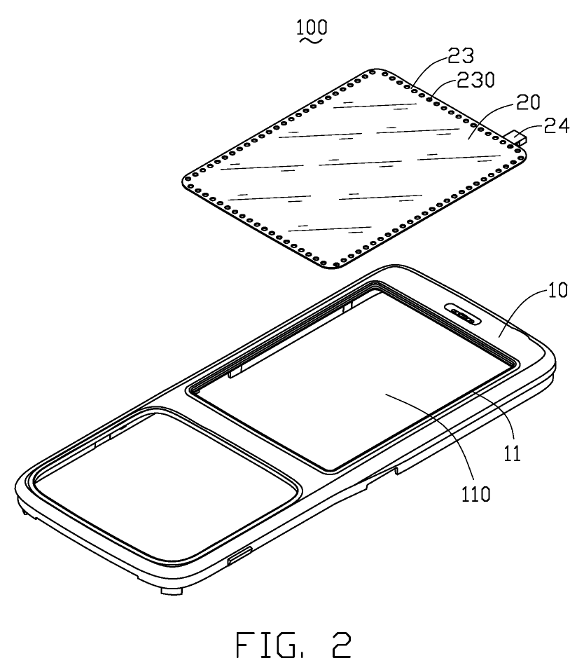

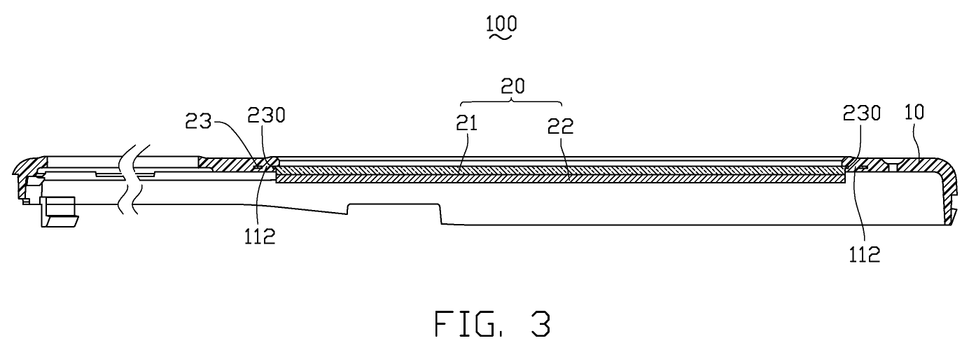

Referring to FIG. 2 and FIG. 3, the housing body 10 is advantageously made of a plastic material. The plastic material can, e.g., be chosen from the following group: polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, and any desired combination thereof. The housing body 10 has an inner rim portion 11, defining a display opening 110 configured for receiving the attached unit 20.

The attached unit 20 may, beneficially, contain electronic ink and thereby use such electronic ink to display characters and images. The attached unit 20 includes a base layer 21 and an electronic ink layer 22. The base layer 21 is a transparent film, which can be made from plastic, glass, or other transparent materials. The electronic ink layer 22 is spread on a surface of the base layer 21.

The attached unit 20 also includes an outer rim portion 23 projecting from a flange thereof and an electric connector 24 formed on one portion of the flange thereof. The outer rim portion 23 has a plurality of through holes 230 formed therein. The electrical connector 24 is configured for electrically connecting the attached unit 20 with a printed circuit board or any of other electronic elements (none shown) received in the housing 100.

The housing body 10 is moldingly attached (i.e., co-molded) with the attached unit 20, with the attached unit 20 being received into the display opening 110 of the housing body 10. The molding step insures that the outer rim portion 23 of the attached unit 20 is inserted into (i.e., fittingly received within) the inner rim portion 11 of the housing body 10, with at least one injection body 112 of the inner rim portion 11 being engaged in a respective through hole 210 of the outer rim portion 23. Thus, an interference/sealing fit between the attached unit 20 and the display opening 11 of the housing body 10 is achieved, providing an airtight and dustproof fit for the housing assembly 100. Furthermore, each injection body 112 is formed during molding and extends through a respective through hole 230. As such, each injection body 112 is a molded through-pin integral with the inner rim portion 11 of the housing body 10 and helps to ensure and maintain the alignment of the attached unit 20 relative to the housing body 10.

It is to be understood that the compatibility of the materials used for the housing body 10 and the attached unit 20 could effectively create/yield a plastic weld between such elements. Additionally, the attached unit 20 is moldingly received in the housing body 10, and thus the attached unit 20 does not require being glued or otherwise adhesively bonded onto the housing body 10 and being pressed by a roller. In this method, cost of the housing assembly 100 is decreased, and manufacturing efficiency and quality of the housing assembly 100 are improved.

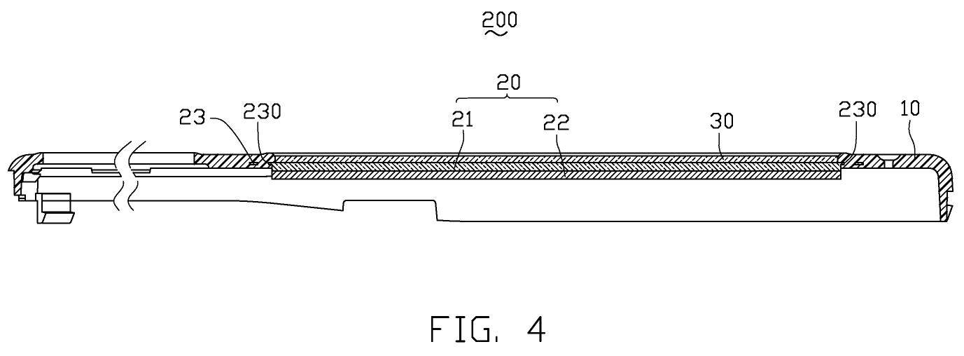

Referring to FIG. 4, in another current embodiment, a housing assembly 200, similar to the housing assembly 100, may further include a display lens 30. The display lens 30 is also received in the display opening 11 and covers the attached unit 20 so as to protect the attached unit 20 from being scratched. It is to be understood that such a display lens 30 might additionally be designed to improve one or more optical properties (e.g., glare-reduction, color and/or UV filtering, display magnification, etc.). The housing body 10 is moldingly attached to the attached unit 20 and the display lens 30.

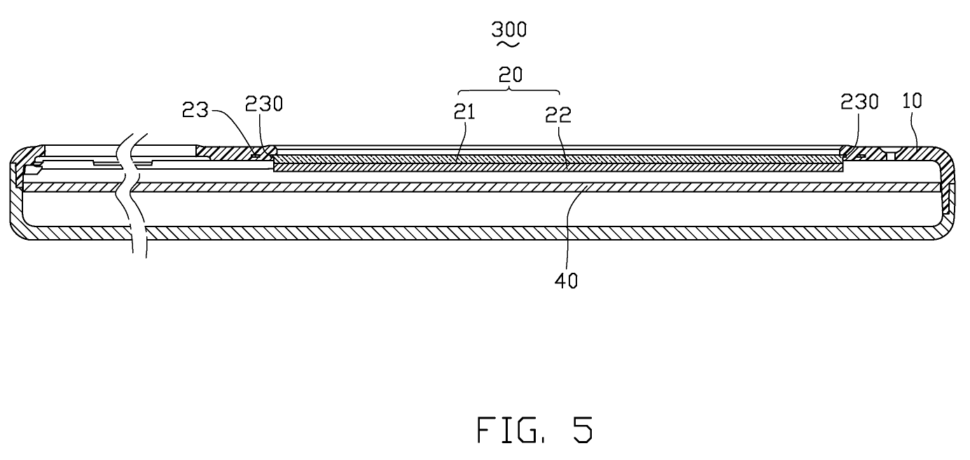

Referring to FIG. 5, the housing assembly 100 can be used in an electronic device (e.g., a mobile phone, digital camera, or PDA) 300, with a printed circuit board 40 received therein. The electrical connector 21 of the attached unit 20 is electrically connected to the printed circuit board 40, so as to enable the attached unit 20 to provide information or graphics thereon, in accordance with signals received from the printed circuit board 40.

An opportune method for making the housing assembly 100 is provided. Firstly, the attached unit 20 is provided. The attached unit 20 is an electronic-ink-carrying attached unit, as per the present embodiments.

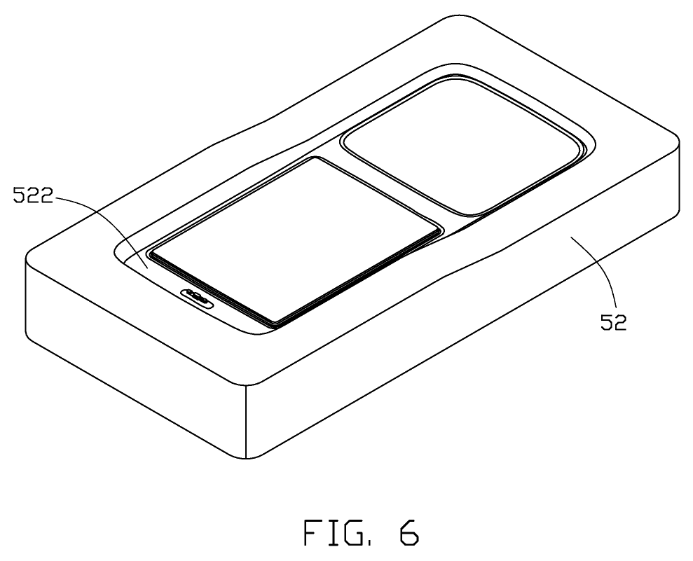

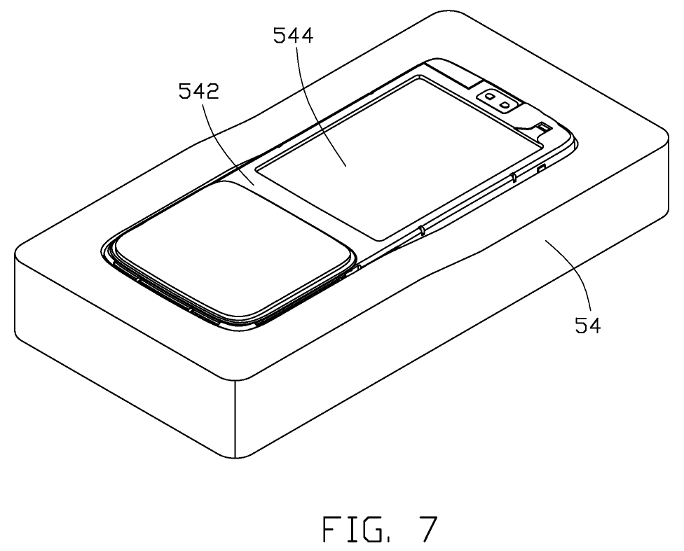

Secondly, an injection mold is provided. Referring to FIG. 6 and FIG. 7, the injection mold includes a female mold 52 and a male mold 54. The female mold 52 has a recessed portion 522 formed therein. The male mold 54 has a mold core 542 mounted thereon. The mold core 542 has a receiving groove 544 formed therein and is configured for partially receiving the attached unit 20. The male mold 54 is matingly engageable with the female mold 52.

Thirdly, a bottom portion of the attached unit 20 is fixed into the receiving groove 544 of the molding core 542, with a top portion of the attached unit 20 projecting out of the molding core 542.

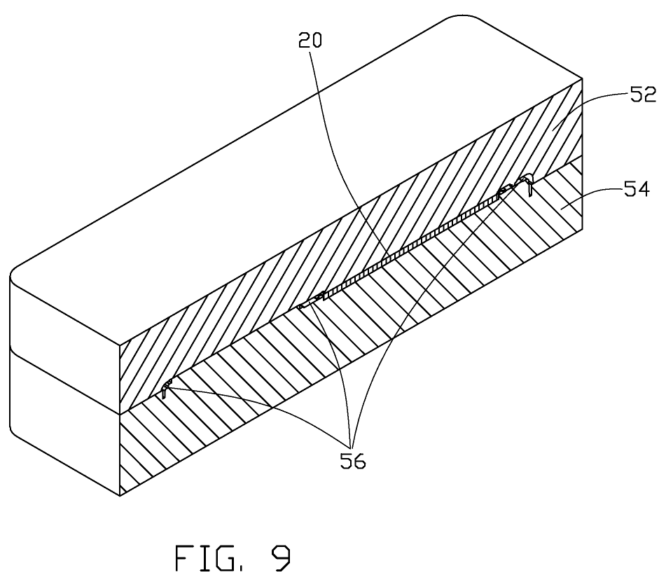

Fourthly, referring to FIG. 9, the injection mold 50 is sealed by engaging the male mold 54 with the female mold 52, therefore a molding cavity 56 is defined. Fifthly, molten plastic is injected into the molding cavity 56. Thus, the housing body 10 is moldingly attached to (i.e., fittingly formed around) the attached unit 20 in the molding cavity 56 by injection molding, with at least one injection body 112 being concurrently formed during molding and thereby extending through a corresponding through hole 230. Such injection bodies 112 help holding the attached unit 20 in place relative to the housing body 10. The housing body 10 is preferably made of a plastic material, as described above. If the materials of the housing body 10 and the attached unit 20 suitably match, a plastic weld therebetween may concurrently result.

Finally, the injection mold is cooled down, and the housing assembly 100, including the housing body 10 and the attached unit 20 is obtained.

It should be understood that the attached unit 20 is fixed to the housing body 10 by such an injection molding process, effectively creating an interference fit, and, quite likely, a plastic weld therebetween. Thus, in the process of making the housing assembly 100, it is unnecessary to further fix the attached unit 20 to the housing body 10 by using an additional adhesive and/or small bolts. The attached unit 20 and the housing body 10 can be joined together with a concordant seal without gap. As such, the cover can obtain a highly airtight, water-resistant, and dustproof seal.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing for a mobile device, comprising:
a housing body defining a display opening therein; and
an attached unit moldingly received in the housing body within the display opening, the attached unit including a base layer and an electronic ink layer.

2. The housing as claimed in claim 1, wherein the housing body is made of a plastic material.

3. The housing as claimed in claim 1, wherein the base layer is a transparent film.

4. The housing as claimed in claim 1, wherein the attached unit has a flange and an outer rim portion projecting from the flange, the outer rim portion having a plurality of through holes formed therein, the outer rim portion of the attached unit being received within an inner rim portion of the housing body, with at least one injection body of the inner rim portion being engaged in a respective through hole of the outer rim portion.

5. The housing as claimed in claim 1, wherein the attached unit has an electric connector formed on one end thereof.

6. The housing as claimed in claim 1, further including a display lens received in display opening, the display lens being configured for protecting the attached unit.

7. The housing as claimed in claim 6, wherein the display lens covers the attached unit, the housing body moldingly receiving the display lens.

8. A mobile electronic device, comprising:
a printed circuit board; and
a housing receiving the printed circuit board, the housing comprising:
a housing body carrying a printed circuit board, the housing body further defining a display opening; and
an attached unit including a base layer and an electronic ink layer and received in the display opening, the attached unit being electrically connected to the printed circuit board so as to enable the attached unit to display graphical information, the housing body moldingly receiving the attached unit therein.

9. The mobile electronic device as claimed in claim 8, wherein the housing body is made of a plastic material.

10. The mobile electronic device as claimed in claim 8, wherein the attached unit has an electric connector formed on one end thereof, the electric connector being electrically connected to the printed circuit board.

11. The mobile electronic device as claimed in claim 8, wherein the housing further includes a display lens received in display opening, the display lens being configured for protecting the attached unit.

12. The mobile electronic device as claimed in claim 11, wherein the display lens covers the attached unit, the housing body moldingly receiving the display lens.

13. The mobile electronic device as claimed in claim 1, wherein the display lens covers the attached unit and is fixed to the housing body via an additional adhesive.

14. A method for making a housing assembly, comprising the steps of:
providing an attached unit, the attached unit including a base layer and an electronic ink layer;
inserting the attached unit into a mold, with a mold cavity defined in the mold; and
injecting a molten plastic into the mold cavity to form a housing body, with the housing body resultantly being moldingly attached to the attached unit.

15. The method as claimed in claim 14, wherein the attached unit has a flange and an outer rim portion projecting from the flange, the outer rim portion having a plurality of through holes formed therein, at least one injection body of the housing body being concurrently formed during molding and extending through a respective one of the through holes.
